(19) United States
(12) Patent Application Publication
(10) Pub. No.: US 2019/0162572 A1
(43) Pub. Date: May 30, 2019

(54) WATER WASTAGE DETECTION SYSTEM

(71) Applicant: International Business Machines Corporation, Armonk, NY (US)

(72) Inventors: Vitobha Munigala, Bangalore (IN); SRIKANTH G. TAMILSELVAM, Chennai (IN); Manikandan Padmanaban, Karnataka (IN); Jagabondhu Hazra, Bangalore (IN)

(21) Appl. No.: 15/825,133

(22) Filed: Nov. 29, 2017

(51) Int. Cl. G01F 15/075; G01F 15/00; E03B 7/07

(52) U.S. Cl. CPC G01F 15/0755; E03B 7/075; E03B 7/072; G01F 15/003

(57) ABSTRACT

An indication of water flowing into a fixture and down a drain of the fixture is received. A timer is started. A flow rate and attributes of the water flowing into the fixture are monitored. Attributes of the water flowing through the drain are monitored. A determination is made that the attributes of water flowing into the fixture match, within a threshold, the attributes of water flowing through the drain. A first duration of time of water being wasted is determined. A determination is made that water flowing into the fixture has stopped. A total duration of time of water being wasted, based on at least the first duration of time, is determined. A volume of water being wasted is determined based on the total duration of time and the flow rate.

### BACKGROUND

The present invention relates generally to the field of household water usage, and more particularly to determining water waste.

Water is an extremely valuable natural resource. The most important use of water is for consumption by humans, other animals, and plants. Water can be drawn for use from wells in the ground, from lakes and other bodies of water, from rivers and other types of running water, and from precipitation (capturing rainwater, melting snow, etc.). During periods of drought or when water availability is limited for some other reason, conservation of water is important to ensure that sufficient water is available for important needs.

### SUMMARY OF THE INVENTION

Embodiments of the present invention include an approach for determining water waste. In one embodiment, an indication of water flowing into a fixture and down a drain of the fixture is received. A timer is started. A flow rate and attributes of the water flowing into the fixture are monitored. Attributes of the water flowing through the drain are monitored. A determination is made that the attributes of water flowing into the fixture match, within a threshold, the attributes of water flowing through the drain. A first duration of time of water being wasted is determined. A determination is made that water flowing into the fixture has stopped. A total duration of time of water being wasted, based on at least the first duration of time, is determined. A volume of water being wasted is determined based on the total duration of time and the flow rate.

### BRIEF DESCRIPTION OF THE DRAWINGS

FIG. 1 depicts a functional block diagram of a computing environment, in accordance with an embodiment of the present invention;

FIG. 2 depicts a flowchart of a program for determining water waste, in accordance with an embodiment of the present invention;

FIG. 3 depicts a flowchart of a program for determining a household make-up, a dynamic price of water, and a penalty based on water wasted in the household, in accordance with an embodiment of the present invention; and

FIG. 4 depicts a block diagram of components of the computing environment of FIG. 1, in accordance with an embodiment of the present invention.

### DETAILED DESCRIPTION

Embodiments of the present invention provide for determining water waste. When a person brushes their teeth, and allows the water to run into the sink while brushing, clean water is being wasted as the clean water flows down the drain. Wasting clean water can have an economic impact to the person as the person is charged for water usage based on the total volume of water used in a month, a quarter of a year, or some other time period. Wasting clean water can also have a social impact if the person deprives others of clean water by wasting a large amount of clean water.

Embodiments of the present invention recognize that there is an approach for determining water waste. In an embodiment, a timer starts when water begins flowing into a sink. A sensor determines if the water going down the drain is clean water being wasted or dirty water. The total amount of time that clean water is being wasted is determined. Using the flow rate of the water, the volume of clean water wasted is determined.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention will now be described in detail with reference to the Figures.

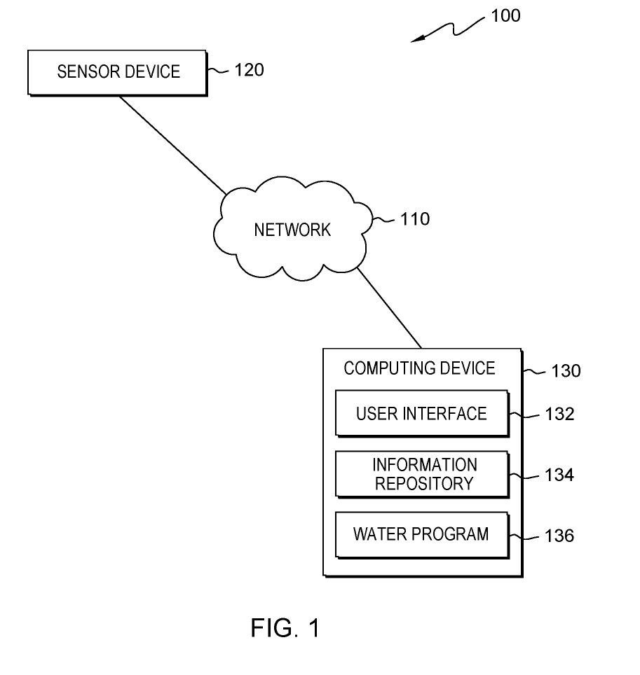

FIG. 1 is a functional block diagram illustrating a computing environment, generally designated 100, in accordance with one embodiment of the present invention. FIG. 1 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

In an embodiment, computing environment 100 includes sensor device 120 and computing device 130, interconnected via network 110. In example embodiments, computing environment 100 may include other computing devices (not shown in FIG. 1) such as smart watches, cell phones, smartphones, wearable technology, phablets, tablet computers, laptop computers, desktop computers, other computer servers or any other computer system known in the art, interconnected to sensor device 120 and computing device 130, over network 110.

In an embodiment of the present invention, sensor device 120 and computing device 130 connect to network 110, which enables sensor device 120 and computing device 130 to access other computing devices and/or data not directly stored on sensor device 120 and computing device 130. Network 110 may be, for example, a short-range, low power wireless connection, a local area network (LAN), a telecommunications network, a wide area network (WAN) such as the Internet, or any combination of the three, and include wired, wireless, or fiber optic connections. Network 110 may include one or more wired and/or wireless networks that are capable of receiving and transmitting data, voice, and/or video signals, including multimedia signals that include voice, data, and video information. In general, network 110 can be any combination of connections and protocols that will support communications between sensor device 120, computing device 130, and any other computing devices connected to network 110, in accordance with embodiments of the present invention. In an embodiment, data received by another computing device (not shown in FIG. 1) in computing environment 100 may be communicated to sensor device 120 and computing device 130 via network 110.

In an embodiment, sensor device 120 is a sensor or combination of sensors that can differentiate clean water from dirty water. According to embodiments of the present invention, sensor device 120 can be a potential of hydrogen (pH) meter, a nephelometer, or any other device capable of differentiating clean water from dirty water. In an embodiment, a pH meter is an instrument that measures the hydrogen-ion activity in water-based solutions, indicating the acidity or alkalinity of the solution expressed as pH. The pH meter measures the difference in electrical potential between a pH electrode and a reference electrode, and so the pH meter is sometimes referred to as a “potentiometric pH meter”. The difference in electrical potential relates to the acidity or pH of the water-based solution. The pH meter is used in many applications ranging from laboratory experimentation to quality control. In an embodiment, a nephelometer is an instrument for measuring concentration of suspended particulates in a liquid. A nephelometer measures suspended particulates by employing a light beam (source beam) and a light detector set to one side (often ninety degrees) of the source beam. Particle density within the liquid is then a function of the light reflected into the detector from the particles.

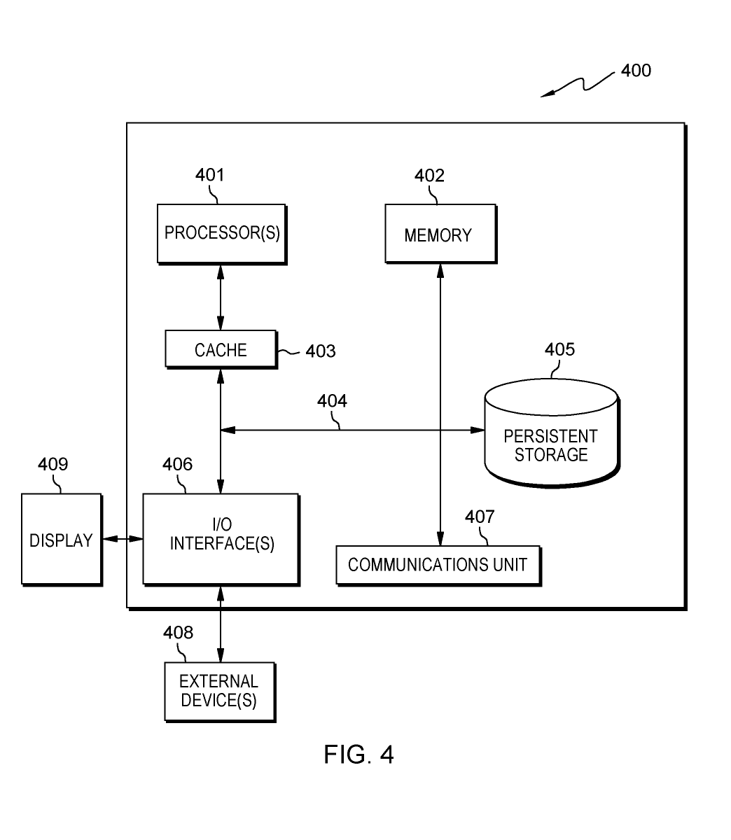

According to an embodiment of the present invention, computing device 130 is a computing device used by a user to access product catalogs and social media websites. In an embodiment computing device 130 may be a laptop, tablet, or netbook personal computer (PC), a desktop computer, a personal digital assistant (PDA), a smartphone, a standard cell phone, a smart-watch or any other wearable technology, or any other hand-held, programmable electronic device capable of communicating with any other computing device within computing environment 100. In certain embodiments, computing device 130 represents a computer system utilizing clustered computers and components (e.g., database server computers, application server computers, etc.) that act as a single pool of seamless resources when accessed by elements of computing environment 100. In general, computing device 130 is representative of any electronic device or combination of electronic devices capable of executing computer readable program instructions. In an embodiment, computing environment 100 includes any number of computing device 130. Computing device 130 includes components as depicted and described in further detail with respect to FIG. 4, in accordance with embodiments of the present invention.

According to an embodiment of the present invention, computing device 130 includes user interface 132, information repository 134, and water program 136. In an embodiment, user interface 132 provides an interface between a user of computing device 130, network 110, and any other devices connected to network 110 such as sensor device 120. User interface 132 allows a user of computing device 130 to interact with the Internet and also enables the user to receive an indicator of one or more previous viewing locations and a summary of viewing history on the Internet. In general, a user interface is the space where interactions between humans and machines occur. User interface 132 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. User interface 132 may also be mobile application software that provides an interface between a user of computing device 130 and network 110. Mobile application software, or an “app,” is a computer program designed to run on smartphones, phablets, tablet computers and other mobile devices.

According to an embodiment of the present invention, information repository 134 may be storage that may be written to and/or read by water program 136. In one embodiment, information repository 134 resides on computing device 130. In another embodiment, information repository 134 may reside on any other device (not shown in FIG. 1) in computing environment 100, in cloud storage or on another computing device accessible via network 110. In yet another embodiment, information repository 134 may represent multiple storage devices within computing device 130. Examples of data stored to information repository 134 include a history of water usage in a household or a business, an amount of clean water wasted down the drain (per household/business drains connected to sinks), and a history of penalties paid for excessive water waste.

In an embodiment, information repository 134 may be implemented using any volatile or non-volatile storage media for storing information, as known in the art. For example, information repository 134 may be implemented with a tape library, optical library, one or more independent hard disk drives, multiple hard disk drives in a redundant array of independent disks (RAID), solid-state drives (SSD), or random-access memory (RAM). Similarly, information repository 134 may be implemented with any suitable storage architecture known in the art, such as a relational database, an object-oriented database, or one or more tables. According to an embodiment of the present invention, water program 136 and any other programs and applications (not shown in FIG. 1) operating on computing device 130 may store, read, modify, or write data to information repository 134.

According to embodiments of the present invention, water program 136 is a program, a subprogram of a larger program, an application, a plurality of applications, or mobile application software, which functions to determine water waste. A program is a sequence of instructions written by a programmer to perform a specific task. In an embodiment, water program 136 receives an indication that water is flowing into a sink. In an embodiment, water program 136 starts a timer. In an embodiment, water program 136 monitors the water going down the drain. In an embodiment, water program 136 differentiates clean water going down the drain (i.e., water waste) from dirty water going down the drain. In an embodiment, in response to the water flow stopping, water program 136 determines the total time water was being wasted. In an embodiment, water program 136 determines the amount of water waste. Water program 136 may run by itself but may be dependent on system software (not shown in FIG. 1) to execute. In one embodiment, water program 136 functions as a stand-alone program residing on computing device 130. In another embodiment, water program 136 may work in conjunction with other programs, applications, etc., found on computing device 140 or on any other computing device (not shown in FIG. 1) in computing environment 100, which are interconnected to computing device 140 via network 110.

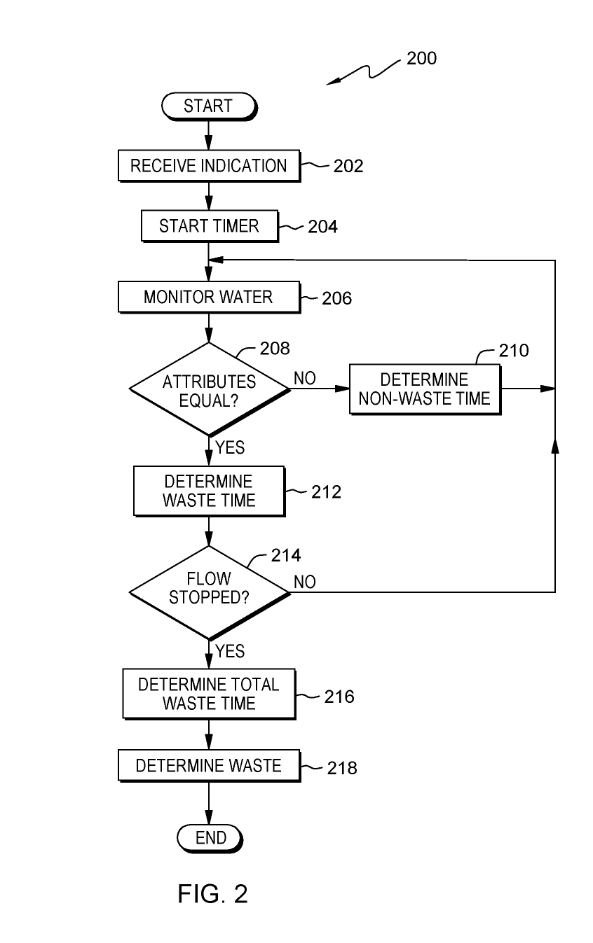

FIG. 2 is a flowchart of workflow 200 depicting an approach for determining water waste. In one embodiment, the method of workflow 200 is performed by water program 136. In an alternative embodiment, the method of workflow 200 may be performed by any other program working with water program 136. In an embodiment, a user may invoke workflow 200 upon powering on computing device 140. In an alternative embodiment, a user may invoke workflow 200 upon accessing water program 136.

In an embodiment, water program 136 receives an indication (step 202). In other words, water program 136 receives an indication that water is flowing into a fixture and water is also going down a drain from that fixture. According to an embodiment of the present invention, water may be flowing into and out of a sink (e.g., kitchen sink, bathroom sink, laundry sink, utility sink, etc.), into a bathing fixture (e.g., a bathtub, shower, etc.), a toilet, or any other fixture that can receive and drain water. In an embodiment, water program 136 receives an indication from sensor device 120 over network 110. For example, “Joe” has turned on the water to a shower stall so that the water warms to a comfortable temperature so that “Joe” can take a shower after mowing the lawn.

In an embodiment, water program 136 starts a timer (step 204). In other words, water program 136 starts a timer so that the duration of time the water is flowing can be determined. In an embodiment, water program 136 can start a timer for timing the water flowing into a single fixture. In another embodiment, water program 136 can start multiple timers for timing the water flowing into multiple fixtures at the same time. According to an embodiment of the present invention, the timer is part of water program 136. According to another embodiment, the timer is part of computing device 130. According to yet another embodiment, the timer is a stand-alone timer accessible via network 110. According to yet another embodiment, the timer is part of sensor device 120. In an embodiment, water program 136 starts a timer which is part of water program 136 upon receiving input that water is flowing. For example, a timer starts when “Joe” turns on the water in the shower.

In an embodiment, water program 136 monitors water (step 206). In other words, water program 136 monitors the water flowing into the fixture. According to an embodiment of the present invention, water program 136 monitors the flow rate of the water into a single fixture. According to another embodiment of the present invention, water program 136 monitors the flow rate of water into any number of fixtures. In the embodiment, water program 136 uses any flow meter known in the art to monitor the flow rate of the water. According to the embodiment of the present invention, water program 136 also monitors the water attributes of the water as the water flows down the drain from the fixture. In the embodiment, water program 136 monitors water attributes such as the potential of hydrogen (pH) and the turbidity. pH is numeric scale used to specify the acidity or basicity of an aqueous solution such as water. pH is the negative of the base ten logarithm of the activity of the hydrogen ion. Solutions with a pH less than seven are acidic and solutions with a pH greater than seven are basic. Pure water is neutral, at pH seven at twenty-five degrees Celsius, being neither an acid nor a base. Turbidity is the cloudiness or haziness of a fluid, such as water, caused by large numbers of individual particles that are generally invisible to the naked eye, similar to smoke in air. The measurement of turbidity is a key test of water quality. Water can contain suspended solid matter consisting of particles of many different sizes. While some suspended material will be large enough and heavy enough to settle rapidly to the bottom of the container if a liquid sample is left to stand (the settable solids), very small particles will settle only very slowly or not at all if the sample is regularly agitated or the particles are colloidal. These small solid particles cause the liquid to appear turbid. In an embodiment, pH is monitored by any pH meter known in the art. In an embodiment, turbidity is monitored by any turbidity meter known in the art, such as a nephelometer, which uses a light beam and a light detector to measure the amount of light reflected by the particles in a liquid. According to an embodiment of the present invention, water program 136 uses data from sensor device 120 received over network 110 to monitor the water flowing down the drain of the fixture.

In an embodiment, water program 136 determines whether attributes are equal (decision step 208). In other words, water program 136 determines whether the attributes of the water flowing into a fixture (i.e., incoming water) are equal to the attributes of the water draining out of the fixture (i.e., outgoing water). In an embodiment (decision step 208, NO branch), water program 136 determines that the attributes are not equal; therefore, water program 136 proceeds to step 210 to determine the non-waste time (i.e., the duration of time that non-clean (or dirty) water is flowing down the drain of the fixture). In the embodiment (decision step 210, YES branch), water program 136 determines that the attributes are equal; therefore, water program 136 proceeds to step 212 to determine the waste time (i.e., the duration of time that clean water is flowing down the drain of the fixture.

In an embodiment, water program 136 determines non-waste time (step 210). In other words, responsive to determining that the water attributes are not equal, water program 136 determines the non-waste time. In an embodiment, the non-waste time is the duration of time that non-waste water (i.e., adulterated or dirty water) is flowing down the drain of the fixture. In an embodiment, non-waste water is water made dirty by soap, human oils, human skin, human hair, dirt, grease, food, animal waste, and the like. According to an embodiment of the present invention, water program 136 determines the non-waste time interval that dirty water is flowing down the drain of the fixture and stores the non-waste time to information repository 134 on computing device 130. For example, “Joe” is using the shower, washing dirt from the hair and body of “Joe” for a duration of ten minutes. During the ten minutes, lawn clippings, soil particles, and soap are going down the shower drain.

In an embodiment, water program 136 determines waste time (step 212). In other words, responsive to determining that the water attributes are equal, water program 136 determines the waste time. In an embodiment, the waste time is the duration of time that waste water (i.e., unadulterated or clean water) is flowing down the drain of the fixture. According to an embodiment of the present invention, water program 136 determines the waste time interval that clean water is flowing down the drain of the fixture and stores the waste time to information repository 134 on computing device 130. For example, “Joe” allows clean water to run down the shower drain for one minute before starting to wash so that the water can reach a comfortable temperature. Also, after washing, “Joe” allows clean water to run down the shower drain for nine minutes while warm water is pulsating against the neck of “Joe” to help relieve neck pain.

In an embodiment, water program 136 determines whether water flow has stopped (decision step 214). In other words, water program 136 determines whether the water flow into the fixture has stopped. In an embodiment (decision step 214, NO branch), water program 136 determines that flow has not stopped; therefore, water program 136 returns to step 206 to continue monitoring the water. In the embodiment (decision step 214, YES branch), water program 136 determines that the water flow has stopped; therefore, water program 136 proceeds to step 216 to determine the total waste time.

In an embodiment, water program 136 determines total waste time (step 216). In other words, responsive to determining that the flow of water has stopped, water program 136 determines the total time waste time (i.e., the total amount of time that clean water was flowing down the drain of the fixture). According to an embodiment of the present invention, the total waste time is the sum of the individual waste time intervals determined in step 210. In an embodiment, there may be no waste time intervals. In another embodiment, there may be one waste time interval. In yet another embodiment, there may be more than one waste time intervals. According to an embodiment of the present invention, water program 136 determines the total non-waste time that clean water is flowing down the drain of the fixture and stores the total non-waste time to information repository 134 on computing device 140. For example, the total time “Joe” allows clean water to flow down the shower drain is ten minutes (one minute while the water reaches a comfortable temperature and nine minutes while warm water pulsates on the neck of “Joe”). Given that the washing portion of the shower taken by “Joe” was ten minutes long, clean water was being wasted fifty percent of the time while clean water was flowing into the shower.

In an embodiment, water program 136 determines waste (step 218). In other words, water program 136 determines the volume of clean water wasted. According to an embodiment of the present invention, water program 136 uses the determined flow rate (units of volume per time period) and the determined total waste time (units in time period) to determine the volume of clean water that flowed down the drain of the fixture. In an embodiment, water program 136 determines the volume of clean water wasted during an individual water-use event. In another embodiment, water program 136 determines the volume of clean water wasted during multiple water-use events happening at the same time. According to an embodiment of the present invention, water program 136 determines the volume of clean water wasted and stores the volume to information repository 134 on computing device 130. For example, “Joe” wasted clean water for a total of ten minutes during a shower. At a flow rate of two gallons per minute, “Joe” wasted twenty gallons of clean water.

According to embodiments of the present invention, water program 136 is a program, a subprogram of a larger program, an application, a plurality of applications, or mobile application software, which functions to determine a household make-up, a dynamic price (i.e., price increase) of water, and a penalty (i.e., price increase) based on water wasted in the household. In an embodiment, water program 136 receives an input regarding the number and ages of the occupants in a household and the location of the household. In an embodiment, water program 136 determines the amount of water used and water wasted by a household and the average amount of water used and water wasted by comparable households in the community. In an embodiment, water program 136 compares the water used and the water wasted. In an embodiment, water program 136 determines if the amount of water used is excessive. In an embodiment, responsive to determining that the amount of water used is excessive, water program 136 determines a dynamic price for the water used. In an embodiment, water program 136 determines if the amount of water wasted is excessive. In an embodiment, responsive to determining that the amount of water wasted is excessive, water program 136 determines a penalty based on the wasted amount of water.

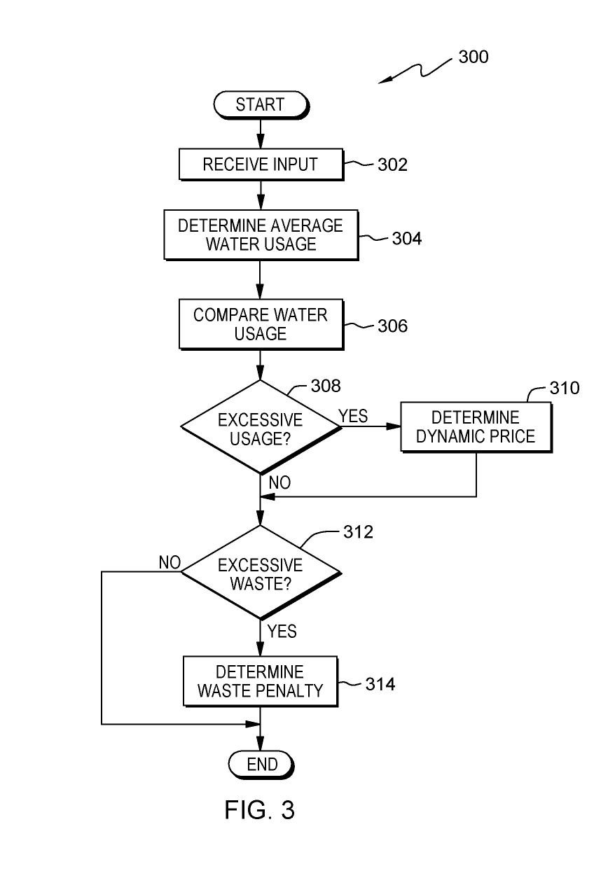

FIG. 3 is a flowchart of workflow 300 depicting an approach for determining a household make-up, a dynamic price (i.e., price increase) of water, and a penalty (i.e., price increase) based on water wasted in the household. In one embodiment, the method of workflow 300 is performed by water program 136. In an alternative embodiment, the method of workflow 300 may be performed by any other program working with water program 136. In an embodiment, a user may invoke workflow 300 upon powering on computing device 140. In an alternative embodiment, a user may invoke workflow 300 upon accessing water program 136.

In an embodiment, water program 136 receives input (step 302). In other words, water program 136 receives input about a household. According to an embodiment of the present invention, water program 136 receives input regarding the location of the household, the number of occupants in the household, and the age of the occupants in the household. In an embodiment, water program 136 receives input from a user. In another embodiment, water program 136 receives input from sensor device 120 over network 110 and determines the make-up of the household based on water attributes over a period of time such as a month (e.g., if the shower is used four distinct times from five-thirty to seven in the morning, water program 136 can infer that there are four users in the house). According to an embodiment of the present invention, water program 136 receives input regarding the make-up of a household from a user of computing device 130 via user interface 132 and the input is stored to information repository 134. For example, “Joe” provides input to the water company that there are three occupants of the household—“Joe” who is thirty years old, a wife who is thirty years old, and a son who is five years old.

In an embodiment, water program 136 determines average water usage (step 304). In other words, water program 136 determines the amount of water used and the amount of water wasted by a household over a time period, such as one month, as well as an average water usage and average water wasted for a comparable household in the community over the time period. According to an embodiment of the present invention, water program 136 uses information collected during workflow 200, such as the total time water was flowing, the determined waste and non-waste times, and the flow rate of the water for each instance of water use, and calculates the total water used by a household by adding the water volume for each instance. In the embodiment, water program 136 determines the average water usage for a comparable household in the community by performing a similar analysis on a plurality of comparable houses in the community and determining an average water usage. In the embodiment, water program 136 determines the amount of waste water from the household and the average amount of water wasted by a comparable household in the community in a similar manner. In the embodiment, water program 136 determines the water used and water wasted for each household in a pre-determined community, finds comparable households based on location, number of occupants, and age of occupants, and calculates an average water usage and water wasted for the comparable households over the time period. In an embodiment, water program 136 uses data from each sensor device 120 from each household in a community, determines the total water used and total water wasted for each household in the community, determines an average water used and an average water wasted for comparable households in the community, and stores the data (household information, location, water used by each household, water wasted by each household, and the determined average water used and wasted by comparable households) to information repository 134 on computing device 140. For example, in the household lived in by “Joe”, the total water used by the household in a month is seven thousand gallons and the total water wasted by the household is five hundred gallons.

In an embodiment, water program 136 compares water usage (step 306). In other words, water program 136 compares the amount of water used by comparable households over a time period and compares the amount of water used to an average amount for the comparable households. According to an embodiment of the present invention, water program 136 compares water usage data stored to memory for each household against the average water usage for comparable households in the community for a time period. In the embodiment, the delta water usage between the household and the average is determined and stored to the memory. In an embodiment, water program 136 retrieves data stored to information repository 134 on computing device 140, compares the water usage of a household against the water usage of a comparable household over a time period, determines the delta between the water usage of the household and the average water usage of the comparable households, and stores the delta to information repository 134. For example, the household of “Joe” used seven thousand gallons of water over the last month. The average water usage for the last month for comparable households (two adults, one child) in the community is five thousand, five hundred gallons. Therefore, the delta in water usage is one thousand, five hundred gallons so the household of “Joe” use a bit over twenty-seven percent more water than the average water usage of a comparable household.

In an embodiment, water program 136 determines whether water usage is excessive (decision step 308). In other words, water program 136 determines whether the delta water usage between a household and a comparable household exceeds a threshold. According to an embodiment of the present invention, the threshold is set by a user. According to another embodiment of the present invention, the threshold is set by an entity such as a water company. According to another embodiment of the present invention, the threshold is set by water program 136 using an algorithm such as the mean plus the standard deviation of the comparable household water usage. In an embodiment (decision step 308, YES branch), water program 136 determines that the water usage of a household is excessive (i.e., exceeds a threshold); therefore, water program 136 proceeds to step 310 to determine a dynamic price of the monthly water used by the household. In the embodiment (decision step 308, NO branch), water program 136 determines that the water usage of a household is not excessive (i.e., does not exceed a threshold); therefore, water program 136 proceeds to step 312 to determine whether the waste water in the household was excessive.

In an embodiment, water program 136 determines dynamic price (step 310). In other words, responsive to determining that the water usage was excessive and that the delta usage exceeded a threshold, water program 136 determines a dynamic price (i.e., price increase) for the water used by the household. In an embodiment, the dynamic price is the normal price for water plus a flat rate penalty, resulting in a price increase for the water used by the household, for exceeding the threshold (e.g., a twenty-dollar penalty). In another embodiment, the dynamic price is the normal price for water plus a scaled penalty, resulting in a price increase for the water used by the household, based on the percentage of excessive water used (e.g., a one percent of the normal price penalty for a ten percent overage, a two percent of the normal price penalty for a twenty percent overage, etc.). According to an embodiment of the present invention, water program 136 determines a dynamic price for the water used by a household based on the amount of water used by the household compared to the average amount of water used by comparable households. For example, since the household of “Joe” used twenty-seven percent more water than the comparable households in the community, “Joe” was required to pay a dynamic price for water usage based on the normal cost of water plus a ten-dollar penalty added to the normal cost.

In an embodiment, water program 136 determines whether waste was excessive (decision step 312). In other words, water program 136 determines whether the delta water wasted between a household and a comparable household exceeds a threshold. According to an embodiment of the present invention, the threshold is set by a user. According to another embodiment of the present invention, the threshold is set by an entity such as a water company. According to another embodiment of the present invention, the threshold is set by water program 136 using an algorithm such as the mean plus the standard deviation of the volume of water wasted between the household and the comparable household. In an embodiment (decision step 312, YES branch), water program 136 determines that the volume of water wasted was excessive (i.e., does exceed a threshold); therefore, water program 136 proceeds to step 314 to determine a waste penalty. In the embodiment (decision step 312, NO branch), water program 136 determines that the volume of water wasted was not excessive (i.e., does not exceed a threshold); therefore, water program 136 ends.

In an embodiment, water program 136 determines waste penalty (step 314). In other words, responsive to determining that the volume of water wasted was excessive, water program 136 determines a waste penalty. According to an embodiment of the present invention, the waste penalty is a flat value (e.g., fifteen-dollars). According to another embodiment, the waste penalty is a scaled dollar amount based on the volume of water wasted (e.g., ten dollars for one hundred gallons of waste water, twenty-dollars for two-hundred fifty gallons, etc.). In an embodiment, water program 136 determines the waste penalty for a household based on the amount of water wasted by the household compared to the average amount of water wasted by comparable households. For example, the household of “Joe” wasted five-hundred gallons of clean water. The average amount of water wasted by comparable households in the community is five-hundred fifty gallons of water. Therefore, “Joe” was not required to pay a waste penalty since the volume of water wasted in the household of “Joe” was less than the average volume of water wasted in the community.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Having described embodiments of an approach for representing an e-mail with an image, it is noted that modifications and variations may be made by persons skilled in the art in light of the above teachings. It is therefore to be understood that changes may be made in the particular embodiments disclosed which are within the scope of the invention as outlined by the appended claims.

FIG. 4 depicts computer system 400, which is an example of a system that includes water program 136. Computer system 400 includes processor(s) 401, cache 403, memory 402, persistent storage 405, communications unit 407, input/output (I/O) interface(s) 406 and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 6405 are computer readable storage media. In this embodiment, memory 402 includes random access memory (RAM). In general, memory 402 can include any suitable volatile or non-volatile computer readable storage media. Cache 403 is a fast memory that enhances the performance of processors 401 by holding recently accessed data, and data near recently accessed data, from memory 402.

Program instructions and data used to practice embodiments of the present invention may be stored in persistent storage 405 and in memory 402 for execution by one or more of the respective processors 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface 406 may provide a connection to external devices 408 such as a keyboard, keypad, a touchscreen, and/or some other suitable input device. External devices 408 can also include portable computer readable storage media such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method comprising:
receiving, by one or more computer processors, an indication of water flowing into a fixture and down a drain of the fixture;
starting, by one or more computer processors, a timer;
monitoring, by one or more computer processors, a flow rate and attributes of water flowing into the fixture;
monitoring, by one or more computer processors, attributes of water flowing through the drain;
determining, by one or more computer processors, that the attributes of water flowing into the fixture match, within a threshold, the attributes of water flowing through the drain;
responsive to determining that the attributes of water flowing into the fixture match, within the threshold, the attributes of water flowing through the drain, determining, by one or more computer processors, a first duration of time of water being wasted;
determining, by one or more computer processors, that water flowing into the fixture has stopped;
responsive to determining that water flowing into the fixture has stopped;
determining, by one or more computer processors, a total duration of time of water being wasted based on, at least, the first duration of time; and
determining, by one or more computer processors, a volume of water being wasted based on the total duration of time and the flow rate.

2. The method of claim 1, further comprising:
determining, by one or more computer processors, that a second set of attributes of water flowing into the fixture do not match, within the threshold, a second set of attributes of water flowing through the drain;
responsive to determining that the second set of attributes of water flowing into the fixture does not match, within the threshold, the second set of attributes of water flowing through the drain, determining, by one or more computer processors, a first duration of time of water not being wasted, and
continuing, by one or more computer processors, to monitor the attributes of water flowing into the fixture and the attributes of water flowing through the drain.

3. The method of claim 1, wherein the attributes of water flowing into the fixture and the attributes of water flowing through the drain are selected from the group consisting of: a potential of hydrogen, and a turbidity.

4. The method of claim 1, further comprising:
receiving, by one or more computer processors, an input about a household, the input comprising a location of the household, a number of occupants of the household, and an age of each occupant of the household;
determining, by one or more computer processors, a volume of water usage of the household and a volume of water wasted over a period of time;
determining, by one or more computer processors, an average volume of water usage by a plurality of comparable households and an average volume of water wasted by the plurality of comparable households over the period of time;
comparing, by one or more computer processors, the volume of water used and the volume of water wasted by the household to the average volume of water used and the average volume of water wasted by the plurality comparable households;
determining, by one or more computer processors, that the volume of water used by the household exceeds, within a second threshold, the average volume of water used by the plurality of comparable households; and
responsive to determining that the volume of water used by the household exceeds, within the second threshold, the average volume of water used by the plurality of comparable households, determining, by one or more computer processors, a price increase for the volume of water used by the household.

5. The method of claim 4, further comprising:
determining, by one or more computer processors, that the volume of water wasted by the household exceeds, within a third threshold, the average volume of water wasted by the plurality of comparable households; and
responsive to determining that the volume of water wasted by the household exceeds, within the third threshold, the average volume of water wasted by the plurality of comparable households, determining, by one or more computer processors, a second price increase for the volume water of wasted by the household.

6. The method of claim 5, wherein the second price increase is selected from the group consisting of: a flat dollar amount, and a scaled dollar amount based on the volume of water wasted.

7. The method of claim 4, wherein determining the volume of water usage of the household and the volume of water wasted comprises: determining, by one or more computer processors, the volume of water usage of the household and the volume of water wasted by the household by adding each instance of water usage and each instance of water wasted over a period of time.

8. A computer program product comprising:
one or more computer readable storage media; and
program instructions stored on the one or more computer readable storage media, the program instructions comprising:
program instructions to receive an indication of water flowing into a fixture and down a drain of the fixture;
program instructions to start a timer;
program instructions to monitor a flow rate and attributes of water flowing into the fixture;
program instructions to monitor attributes of water flowing through the drain;
program instructions to determine that the attributes of water flowing into the fixture match, within a threshold, the attributes of water flowing through the drain;
responsive to determining that the attributes of water flowing into the fixture match, within the threshold, the attributes of water flowing through the drain, program instructions to determine a first duration of time of water being wasted;
program instructions to determine that water flowing into the fixture has stopped;
responsive to determining that water flowing into the fixture has stopped;
program instructions to determine a total duration of time of water being wasted based on, at least, the first duration of time; and
program instructions to determine a volume of water being wasted based on the total duration of time and the flow rate.

9. The computer program product of claim 8, further comprising program instructions stored on the one or more computer readable storage media, to:
determine that a second set of attributes of water flowing into the fixture do not match, within the threshold, a second set of attributes of water flowing through the drain;
responsive to determining that the second set of attributes of water flowing into the fixture does not match, within the threshold, the second set of attributes of water flowing through the drain, determine a first duration of time of water not being wasted, and
continue to monitor the attributes of water flowing into the fixture and the attributes of water flowing through the drain.

10. The computer program product of claim 8, wherein the attributes of water flowing into the fixture and the attributes of water flowing through the drain are selected from the group consisting of: a potential of hydrogen, and a turbidity.

11. The computer program product of claim 8, further comprising program instructions stored on the one or more computer readable storage media, to:
receive an input about a household, the input comprising a location of the household, a number of occupants of the household, and an age of each occupant of the household;
determine a volume of water usage of the household and a volume of water wasted over a period of time;
determine an average volume of water usage by a plurality of comparable households and an average volume of water wasted by the plurality of comparable households over the period of time;
compare the volume of water used and the volume of water wasted by the household to the average volume of water used and the average volume of water wasted by the plurality comparable households;
determine that the volume of water used by the household exceeds, within a second threshold, the average volume of water used by the plurality of comparable households; and
responsive to determining that the volume of water used by the household exceeds, within the second threshold, the average volume of water used by the plurality of comparable households, determine a price increase for the volume of water used by the household.

12. The computer program product of claim 11, further comprising program instructions stored on the one or more computer readable storage media, to:
determine that the volume of water wasted by the household exceeds, within a third threshold, the average volume of water wasted by the plurality of comparable households; and
responsive to determining that the volume of water wasted by the household exceeds, within the third threshold, the average volume of water wasted by the plurality of comparable households, determine a second price increase for the volume water of wasted by the household.

13. The computer program product of claim 12, wherein the second price increase is selected from the group consisting of: a flat dollar amount, and a scaled dollar amount based on the volume of water wasted.

14. The computer program product of claim 11, wherein determining the volume of water usage of the household and the volume of water wasted comprises: determining, by one or more computer processors, the volume of water usage of the household and the volume of water wasted by the household by adding each instance of water usage and each instance of water wasted over a period of time.

15. A computer system comprising:
one or more computer processors;
one or more computer readable storage media; and
program instructions stored on the one or more computer readable storage media for execution by at least one of the one or more computer processors, the program instructions comprising:
program instructions to receive an indication of water flowing into a fixture and down a drain of the fixture;
program instructions to start a timer;
program instructions to monitor a flow rate and attributes of water flowing into the fixture;
program instructions to monitor attributes of water flowing through the drain;
program instructions to determine that the attributes of water flowing into the fixture match, within a threshold, the attributes of water flowing through the drain;
responsive to determining that the attributes of water flowing into the fixture match, within the threshold, the attributes of water flowing through the drain, program instructions to determine a first duration of time of water being wasted;
program instructions to determine that water flowing into the fixture has stopped;
responsive to determining that water flowing into the fixture has stopped;
program instructions to determine a total duration of time of water being wasted based on, at least, the first duration of time; and
program instructions to determine a volume of water being wasted based on the total duration of time and the flow rate.

16. The computer system of claim 15, further comprising program instructions stored on the one or more computer readable storage media for execution by at least one of the one or more computer processors, to:
determine that a second set of attributes of water flowing into the fixture do not match, within the threshold, a second set of attributes of water flowing through the drain;
responsive to determining that the second set of attributes of water flowing into the fixture does not match, within the threshold, the second set of attributes of water flowing through the drain, determine a first duration of time of water not being wasted, and
continue to monitor the attributes of water flowing into the fixture and the attributes of water flowing through the drain.

17. The computer system of claim 15, wherein the attributes of water flowing into the fixture and the attributes of water flowing through the drain are selected from the group consisting of: a potential of hydrogen, and a turbidity.

18. The computer system of claim 15, further comprising program instructions stored on the one or more computer readable storage media for execution by at least one of the one or more computer processors, to:
receive an input about a household, the input comprising a location of the household, a number of occupants of the household, and an age of each occupant of the household;
determine a volume of water usage of the household and a volume of water wasted over a period of time;
determine an average volume of water usage by a plurality of comparable households and an average volume of water wasted by the plurality of comparable households over the period of time;
compare the volume of water used and the volume of water wasted by the household to the average volume of water used and the average volume of water wasted by the plurality comparable households;
determine that the volume of water used by the household exceeds, within a second threshold, the average volume of water used by the plurality of comparable households; and
responsive to determining that the volume of water used by the household exceeds, within the second threshold, the average volume of water used by the plurality of comparable households, determine a price increase for the volume of water used by the household.

19. The computer system of claim 18, further comprising program instructions stored on the one or more computer readable storage media for execution by at least one of the one or more computer processors, to:
determine that the volume of water wasted by the household exceeds, within a third threshold, the average volume of water wasted by the plurality of comparable households; and
responsive to determining that the volume of water wasted by the household exceeds, within the third threshold, the average volume of water wasted by the plurality of comparable households, determine a second price increase for the volume water of wasted by the household.

20. The computer system of claim 19, wherein the second price increase is selected from the group consisting of: a flat dollar amount, and a scaled dollar amount based on the volume of water wasted.
